(19) United States
(12) Patent Application Publication
(10) Pub. No.: US 2018/0147834 A1
(43) Pub. Date: May 31, 2018

(54) Printing Method Using An Ink Jet Head Unit

(71) Applicant: Semes Co., Ltd., Cheonan-si (KR)

(72) Inventor: Suk-Won Jang, Seoul (KR)

(73) Assignee: Semes Co., Ltd., Cheonan-si (KR)

(21) Appl. No.: 15/819,229

(22) Filed: Nov. 21, 2017

(30) Foreign Application Priority Data
Nov. 28, 2016 (KR) 10-2016-0159487
Mar. 28, 2017 (KR) 10-2017-0039083

(51) Int. Cl. B41J 2/045

(52) U.S. Cl. CPC B41J 2/0456; B41J 2/04586

(57) ABSTRACT

In a printing method using an ink jet head unit including a plurality of ink jet heads disposed in a horizontal direction over an object in which each of adjacent end portions of the plurality of ink jet heads has more than one overlapped nozzle, a supply of droplets from each of the nozzles of the plurality of ink jet heads may be identified. A combination of supplies of the droplets from the nozzles of the plurality of ink jet heads may be determined to form a desired pattern on the object. The desired pattern may be formed on the object using the plurality of ink jet heads including the nozzles arranged in accordance with the determined combination of the supplies of the droplets.

### CROSS-REFERENCE TO RELATED APPLICATION

This application claims priorities to Korean Patent Application No. 10-2016-0159487 filed on Nov. 28, 2016 and Korean Patent Application No. 10-2017-0039083 filed on Mar. 28, 2017 in the Korean Intellectual Property Office (KIPO), the contents of which are herein incorporated by reference in their entireties.

### BACKGROUND

### 1. Field

Example embodiments of the invention relate to a printing method using an inkjet head unit. More particularly, example embodiments of the invention relate to a printing method using an inkjet head unit including a plurality of ink jet heads disposed in a horizontal direction over an object in which adjacent end portions of the plurality of ink jet heads have more than one overlapped nozzle, and to a printing method using an inkjet head unit capable of forming a desired pattern on an object by a scan method.

### 2. Related Technology

Recently, a printing apparatus including an ink jet head unit having a plurality of ink jet heads is used to manufacture a flat panel display device. As for the ink jet head unit of the printing apparatus, the plurality of ink jet heads is generally horizontally disposed over a substrate on which a printing process is performed. For example, when the ink jet head unit includes three ink jet heads, these three ink jet heads are arranged in three rows. Here, end portions of adjacent ink jet heads can be connected to one another.

In a printing process performed using the conventional ink jet head unit having the three ink jet heads, the printing process is usually executed on a substrate by a scan method using in the order of a first ink jet head, a second ink jet head and a third ink jet head. Therefore, droplets can be supplied onto the same position of the substrate from nozzles of the ink jet heads.

As for such a printing process using the conventional ink jet head unit, if the supply failure of the droplets that the droplets cannot be supplied onto the same position of the substrate from one nozzle or two nozzles of the three nozzles in each of the first to the third the ink jet heads is generated, the droplets can be provided onto the same position of the substrate from the remaining nozzle(s) of the first to the third the ink jet heads. However, the ink jet head unit including the total ink jet head heads should be changed if the droplets are not provided onto the substrate from all of the nozzles of the ink jet head heads. Further, the conventional ink jet head unit cannot properly improve the uniformity of a thin film formed on the substrate by the droplets supplied from the conventional ink jet head unit even though the thin film does not have sufficient uniformity.

### SUMMARY

It is an object of the invention to provide a printing method using an ink jet head unit capable of forming a desired thin film or a desired pattern on an object even though supply failure of droplets may occur at all nozzles of the ink jet head unit.

According to an aspect of the invention, there is provided a printing method using an ink jet head unit including a plurality of ink jet heads disposed in a horizontal direction over an object in which each of adjacent end portions of the plurality of ink jet heads has more than one overlapped nozzle. In the printing method, a supply of droplets from each of the nozzles of the plurality of ink jet heads may be identified. A combination of supplies of the droplets from the nozzles of the plurality of ink jet heads may be determined to form a desired pattern on the object. The desired pattern may be formed on the object using the plurality of ink jet heads including the nozzles arranged in accordance with the determined combination of the supplies of the droplets.

In some example embodiments, the printing method may additionally include identifying supply conditions of the droplets from each of the nozzles of the plurality of ink jet heads before the determining of the combination of the supplies of the droplets.

In some example embodiments, the identifying of the supply conditions of the droplets may include identifying whether the droplets are supplied from the nozzles onto the object or not, and identifying a volume of the droplets supplied onto the object.

In example embodiments, the ink jet head unit may include three ink jet heads disposed in a substantial step structure.

In example embodiments, the identifying of the supply of droplets may be performed on overlapped nozzles of the plurality of ink jet heads and/or nozzles disposed at both end portions of a central ink jet head.

According to another aspect of the invention, there is provided printing method using an ink jet head unit including a plurality of ink jet heads disposed in a horizontal direction over an object, wherein each of adjacent end portions of the plurality of ink jet heads having more than one overlapped nozzle, and a length in which total nozzles of the plurality of ink jet heads are arranged is defined as a first length.

In the printing method, a first pattern formed on the object by supplying droplets onto the object from the nozzles arranged by the first length may be identified. To form a desired pattern in comparison with the first pattern, a second pattern formed on the object by changing the length of the nozzles to a second length substantially smaller than the first length may be identified, or a third pattern formed on the object by changing the length of the nozzles to a third length substantially larger than the first length may be identified. The desired pattern may be formed on the object using the ink jet heads having the nozzles arranged by one length of the first length to the third length to the desired pattern.

In example embodiments, each of the identifying of the first pattern, the identifying of the second pattern or the identifying of the third pattern may be identifying supply conditions of the droplets from each of the nozzles arranged by the first length, the second length or the third length.

In example embodiments, the identifying of the supply conditions of the droplets may include identifying whether the droplets are supplied from the nozzles onto the object or not, and identifying a volume of the droplets supplied onto the object.

In example embodiments, the ink jet head unit includes three ink jet heads disposed in a substantial step structure.

In example embodiments, the length of the nozzles may be changed from the first length to the second length or the third length in accordance with supply of droplets from nozzles disposed at end portions of the plurality of ink jet heads.

According to still another aspect of the invention, there is provided a printing method using an ink jet head unit to form a desired pattern on an object. In the printing method, a first pattern formed on the object by a first scan process using the ink jet head unit may be identified. It may be identified a second pattern formed on the object by a second scan process using the ink jet head unit including nozzles arranged to be overlapped with the first pattern by a size of a first overlapped region. It may be identified a third pattern formed on the object by a third scan process using the ink jet head unit including the nozzles arranged to be overlapped with the second pattern by a size of a second overlapped region substantially larger than the first overlapped region, or a fourth pattern formed on the object by a fourth scan process using the ink jet head unit including the nozzles arranged to be overlapped with the third pattern by a size of a third overlapped region substantially smaller than the first overlapped region. The desired pattern may be formed on the object by an additional scan process using the ink jet head unit including the nozzles arranged to be overlapped with the third pattern or the fourth pattern by a size of a desired overlapped region among the first overlapped region to the third overlapped region.

In example embodiments, the ink jet head unit may include at least one ink jet head.

In some example embodiments, the ink jet head unit may include a plurality of ink jet heads. The plurality of ink jet heads may be disposed in a substantial line over the object. Alternatively, the plurality of ink jet heads may be disposed over the object in a substantial step structure along a horizontal direction. Each of adjacent end portions of the plurality of ink jet heads may have an overlapped region.

In the printing method using the ink jet head unit according to example embodiments of the invention, the supply of droplets from each of the nozzles may be identified and the combination of supplies of the droplets from the nozzles may be determined. Therefore, the desired pattern or the desired thin film may be formed on the object using the ink jet head unit including the nozzles arranged in accordance with the determined combination of the supplies of the droplets. Further, the desired pattern or the desired thin film may be formed on the object by the scan processes using the ink jet head unit including the nozzles arranged to be overlapped by the size of the desired overlapped region. Accordingly, the supply failure of the droplets may be sufficiently compensated because the droplets may be provided onto the same position of the object from other overlapped nozzles even though the supply failure of the droplets may be caused at all of the nozzles supplying the droplets onto the same position of the object. Moreover, the supply conditions of droplets from each of the nozzles may be identified and the printing process may be performed on the object while adjusting the length of the nozzles based on the identified supply conditions, so that the thin film or the pattern having the desired uniformity may be formed on the object.

### BRIEF DESCRIPTION OF THE DRAWINGS

Example embodiments will be more clearly understood from the following detailed description taken in conjunction with the accompanying drawing. The following figures represent non-limiting, example embodiments as described herein.

FIGS. 1 and 2 are schematic diagrams illustrating a printing method using an ink jet head unit in accordance with example embodiments of the invention.

FIGS. 3 to 5 are schematic diagrams illustrating a printing method using an ink jet head unit in accordance with some example embodiments of the invention.

### DESCRIPTION OF EMBODIMENTS

Various embodiments will be described more fully hereinafter with reference to the accompanying drawings, in which some embodiments are shown. The invention may, however, be embodied in many different forms and should not be construed as limited to the embodiments set forth herein. Rather, these embodiments are provided so that this description will be thorough and complete, and will fully convey the scope of the invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (for example, rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include a plurality of forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the face through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a printing method using an ink jet head according to example embodiments of the invention will be described with reference to the accompanying drawings.

In example embodiments, a printing apparatus for performing the printing method using an ink jet head may be used in a process of forming a pattern on an object such as a substrate in processes for manufacturing a flat panel display device. For example, the printing apparatus may perform a process of forming a thin film on the object, a process of forming a desired image on the object, etc.

The printing apparatus according to example embodiments may include an ink jet head capable of providing droplets onto the object such as the substrate in an ink jet method. The ink jet head may include a plurality of nozzles for spraying the droplets onto the object. Here, the plurality of nozzles of the ink jet head may be substantially arranged in a line by a predetermined pitch. In some example embodiments, the nozzles may have a plurality of piezoelectric elements, and the number of the piezoelectric elements may be substantially the same as the number of the nozzles. The droplets may be discharged from the nozzles onto the object by the operation of the piezoelectric elements. In this case, the amounts of the droplets sprayed from the nozzles onto the object may be substantially independently adjusted by controlling voltages applied to the piezoelectric elements.

In example embodiments, the printing apparatus may include an ink jet head unit which may have a plurality of ink jet heads. In this case, the printing apparatus may include an ink jet head unit provided by the pack unit. For example, the printing apparatus may include a packaged ink jet head unit.

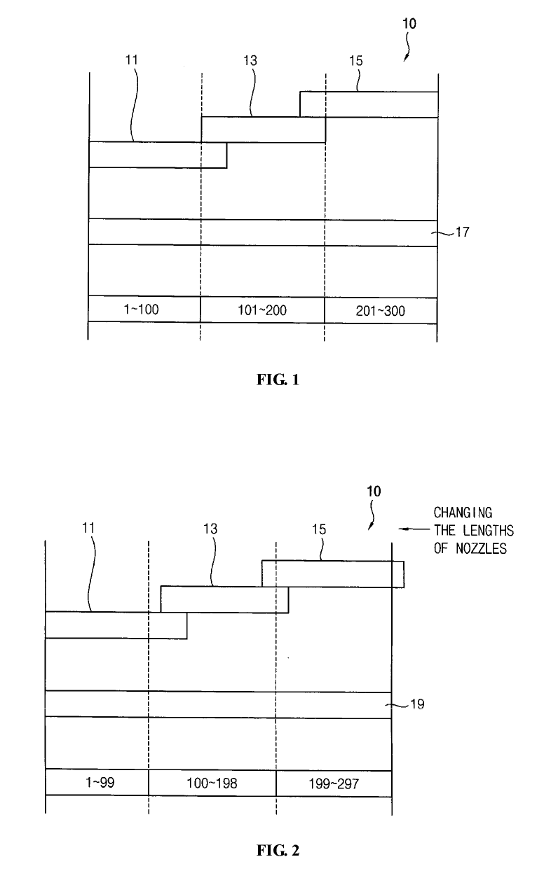

FIGS. 1 and 2 are schematic diagrams illustrating the printing method using the ink jet head unit in accordance with example embodiments of the invention.

Referring to FIGS. 1 and 2, a printing apparatus according to example embodiments may include an ink jet head unit 10 by the pack unit.

The ink jet head unit 10 may include a plurality of ink jet heads 11, 13 and 15. In example embodiments, the plurality of ink jet heads 11, 13 and 15 may be disposed in a substantial step structure along a horizontal direction over an object such as a substrate. Here, end portions of the plurality of ink jet heads 11, 13 and 15 may be substantially overlapped to provide the step structure. When the plurality of ink jet heads 11, 13 and 15 are disposed in the substantial step structure along the horizontal direction, each of adjacent end portions of the plurality of ink jet heads 11, 13 and 15 may have more than one substantially overlapped nozzle. For example, in the ink jet head unit 10 including the plurality of ink jet heads 11, 13 and 15, both end portions of the central ink jet head 13 may be overlapped with one end portion of the left ink jet head 11 and one end portion of the right ink jet head 15, respectively. In this case, each of the end portions of the central ink jet head 13, one end portion of the left ink jet head 11 and one end portion of the right ink jet head 15 may include more than one substantially overlapped nozzle.

In example embodiments, the ink jet head unit 10 may include three ink jet heads 11, 13, and 15 as described above. For example, the ink jet head unit 10 may have a first ink jet head 11, a second ink jet head 13 and a third ink jet head 15 disposed over the object in the step structure in which the second ink jet head 13 is disposed on the first ink jet head 11, and the third ink jet head 15 is located on the second ink jet head 13. Here, both end portion of the second ink jet head 13 may be substantially overlapped with a right end portion of the second ink jet head 11 and a left end portion of the third ink jet head 15.

In the ink jet head unit 10 according to example embodiments, more than one nozzle disposed at one end portion of the first ink jet head 11 may be substantially overlapped with more than one nozzle positioned at one end portion of the second ink jet head 12, and also more than one nozzle disposed at the other end portion of the second ink jet head 12 may be substantially overlapped with more than one nozzle located at one end portion of the third ink jet head 15. In this case, the length in which the whole nozzles of the first to the third ink jet heads 11, 13 and 15 are arranged over the object may be defined as a “first length.” For example, the length from the other end portion of the first ink jet head 11 to the other end portion of the third ink jet head 15 may be defined as the first length. More particularly, the first length may be defined as the length from one nozzle of the nozzles provided at the other end portion of the first ink jet head 11 to one nozzle of the nozzles provided at the other end portion of the third ink jet head 15.

As described above, the plurality of ink jet heads 11, 13 and 15 may include a plurality of nozzles, respectively. In example embodiments, about 100 nozzles may be provided to the plurality of ink jet heads 11, 13 and 15, respectively. For example, the first ink jet head 11 may include a first nozzle to a one hundredth nozzle, the second ink jet head 13 may have a one hundred and first nozzle to a two hundredth nozzle, and the third ink jet head 15 may include a two hundred and first nozzle to a three hundred nozzle.

In example embodiments, a ninety-eighth nozzle, a ninety-ninth nozzle and the one hundredth nozzle of the first ink jet head 11 may be respectively overlapped with the one hundred and first nozzle, a one hundred and second nozzle and a one hundred and third nozzle of the second ink jet head 13 in a substantially identical line. Further, a one hundred and ninety-eighth nozzle, a one hundred and ninety-ninth nozzle and the two hundredth nozzle of the second ink jet head 13 may be respectively overlapped with the two hundred and first nozzle, a two hundred and second nozzle and a two hundred and third nozzle of the third ink jet head 15. Here, the first length may be defined as the distance between the first nozzle of the first ink jet head 11 and the three hundredth nozzle of the third ink jet head 15. Meanwhile, the first length may be defined as a dimension of a printing area 17 of the object where a printing process using the ink jet head unit 10 may be performed.

According to example embodiments, the printing process may be performed on the object such as the substrate using the ink jet head unit 10 including the plurality of ink jet heads, that is, the first ink jet head 11 to the third ink jet head 15.

In the printing process, as illustrated in FIG. 1, droplets may be supplied onto the object from the first nozzle to a ninety-seventh nozzle of the first ink jet head 11, and droplets may be sprayed onto the object from a one hundred and fourth nozzle to a one hundred and ninety-seventh nozzle of the second ink jet head 13. Additionally, droplets may be supplied onto the object from a two hundred and fourth nozzle to the three hundredth nozzle of the third ink jet head 15. Moreover, at the substantially overlapped end portions of the first to the third ink jet heads 11, 13 and 15, droplets may be provided onto the object from one of the ninety-eighth nozzle and the one hundred and first nozzle, one of the ninety-ninth nozzle and the one hundred and second nozzle, one of the one hundredth nozzle and the one hundred and third nozzle, one of the one hundred and ninety-eighth nozzle and the two hundred and first nozzle, one of the one hundred and ninety-ninth nozzle and the two hundred and second nozzle, or one of the two hundredth nozzle and the two hundred and third nozzle.

In example embodiments, to form a desired pattern (e.g., a pattern having a desired dimension, a desired shape, etc.) on the object by the droplets supplied from the nozzles of the first to the third ink jet heads 11, 13 and 15, each of the nozzles may be checked whether the supply of the droplets is accomplished or not. Further, the combination of the supply of the droplets from each of the nozzles may be identified. The nozzles of the first to the third ink jet heads 11, 13 and 15 may be arranged by the first length as described above, a dimension and/or a shape of a first pattern formed on the object by the droplets supplied from the nozzles may be identified. According to example embodiments, a second pattern may be formed on the object by changing the length of the total nozzles from the first length to a second length substantially smaller than the first length. Alternatively, a third pattern may be formed on the object by changing the length of the total nozzles from the first length to a third length substantially larger than the first length. In these cases, the dimension and/or the shape of the second pattern or the third pattern may be identified. Further, the identified dimension and/or the shape of the second pattern or the third pattern may be compared with the identified dimension and/or the shape of the first pattern. Accordingly, it may be identified whether a dimension and/or a shape of a thin film formed on the object by the droplets supplied from the nozzles of the plurality of ink jet heads 11, 13 and 15 are substantially uniform or not over the entire printing area 17 of the object.

In example embodiments, the combination of the supply of the droplets from each of the nozzles may be identified with respect to the substantially overlapped nozzles among the nozzles of the first to the third ink jet heads 11, 13 and 15 and/or the nozzles disposed at the end portions of the second ink jet head 13. In other words, the length in which the nozzles are arranged may be changed from the first length to the second length or the third length in accordance with the determination that whether the droplets are supplied from the substantially overlapped nozzles of the first to the third ink jet heads 11, 13 and 15 and/or the nozzles disposed at the end portions of the second ink jet head 13 onto the object, or not.

If the droplets are not uniformly supplied onto the entire printing area 17 of the object from the nozzles of the plurality of ink jet heads 11, 13 and 15, the failure such as stain may be generated in the pattern formed on the object or the uniformity of the dimension of the thin film formed on the object may be deteriorated, so that the combination of the supply of the droplets from each of the nozzles may be determined.

In some example embodiments, before the combination of the supply of the droplets from each of the nozzles is determined, the supply conditions of the droplets from each of the nozzles of the plurality of ink jet heads 11, 13 and 15 may be identified. Here, the identification of the supply conditions of the droplets may include the identification that the droplets are supplied from the nozzles onto the object or not, the identification of the volume of the droplets supplied onto the object from the nozzles, etc. For example, it is identified whether the droplets may be properly supplied onto the object from each of the first nozzle to the three hundredth nozzle, whether the droplets are provided onto the object from each of the nozzles by a set volume, etc. In this case, the supply of the droplets from the nozzles may be identified using a vision device such as camera, and the volume of the droplets on the object may be identified using a detection device such as a laser diffraction device.

According to example embodiments, the supply conditions of the droplets from each of the nozzles may be identified to determine the combination of the supplies of the droplets from the total nozzles, which can form the desired pattern on the object. Therefore, the desired pattern may be formed on the object by providing the droplets onto the object from each of the nozzles in accordance with the determined combination of the supplies of the droplets. In this case, the dimension and/or the shape of the first pattern formed on the object by a first combination of the supplies of the droplets from the nozzles arranged in the first length may be compared with the dimension and/or the shape of the second pattern formed on the object by a second combination of the supplies of the droplets from the nozzles arranged in the second length, or the dimension and/or the shape of the third pattern formed on the object by a third combination of the supplies of the droplets from the nozzles arranged in the third length. For example, if the second pattern has the dimension and/or the shape substantially identical to the dimension and/or the shape of the desired pattern, the droplets may be supplied onto the object from the nozzles arranged in the second length. Alternatively, the droplets may be supplied onto the object from the nozzles arranged in the first length or the third length when the first pattern or the third pattern has the dimension and/or the shape substantially identical to the dimension and/or the shape of the desired pattern.

In some example embodiments, the length of the nozzles of the plurality of ink jet heads 11, 13 and 15 may be changed from the first length to the second length as illustrated in FIG. 2. Here, the second length may be defined a distance from the first nozzle of the first ink jet head 11 to the two hundred and ninety-seventh nozzle of the third ink jet head 15. In other words, the second length may be defined as the dimension of the printing area 17 of the object on which the printing process is performed using the ink jet head unit 10.

As described above, the supply of the droplets from each of the nozzles may be identified, and then the desired pattern may be formed on the object using the plurality of ink jet heads 11, 13 and 15 after determining the combination of the supply conditions of the droplets to form the desired pattern. That is, the desired pattern may be formed on the object using the plurality of ink jet heads 11, 13 and 15 which include the nozzles arranged in the length to provide the desired pattern among the first length to the third length.

In the printing method using the ink jet head unit 10 according to example embodiments, the supply of the droplets from each of the nozzles may be identified, and then the combination of the supply conditions of the droplets to form the desired pattern on the object may be determined. Accordingly, the desired pattern may be formed on the object using the plurality of ink jet heads 11, 13 and 15 including the nozzles arranged in the length according to the determined combination.

According to example embodiments of the invention, although the supply failure of the droplets that the droplets may not be properly supplied from all of the nozzles of the plurality of ink jet heads 11, 13 and 15 onto the same position on the object from the nozzles may be occurred, such supply failure of the droplets may be compensated by changing the sequence of the nozzles supplying the droplets onto the same position of the object. For example, when the fourth nozzle of the first ink jet head 11, the one hundred and third nozzle of the second ink jet head 13 and the two hundred and second nozzle of the third ink jet head 15 supply the droplets onto the same position of the object (hereinafter, referred to as ‘a first position’), the length of the nozzles may vary if the supply failure of the droplets may occur at all of those nozzles. For example, the seventh nozzle of the first ink jet head 11, the one hundred and fifth nozzle of the second ink jet head 13 and the two hundred and second nozzle of the third ink jet head 15 may supply the droplets onto the first position on the object the instead of the fourth nozzle of the first ink jet head 11, the one hundred and third nozzle of the second ink jet head 13 and the two hundred and second nozzle of the third ink jet head 15. Therefore, a desired pattern or a desired thin film may be formed on the object by compensating the supply failure of the droplets from the nozzles.

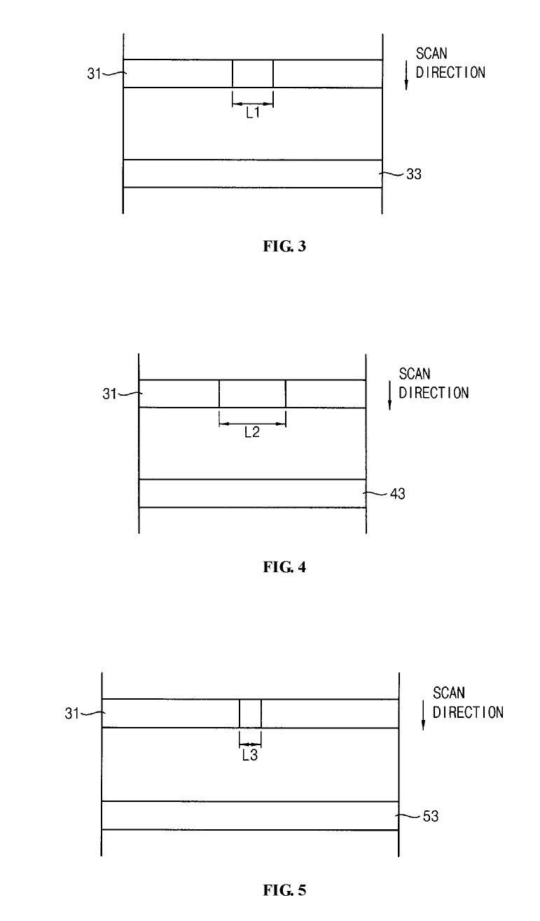

FIGS. 3 to 5 are schematic diagrams illustrating a printing method using an ink jet head unit in accordance with some example embodiments of the invention.

In the printing method using an ink jet head unit illustrated in FIGS. 3 to 5, a pattern or a thin film having a desired dimension and/or a shape may be formed on an object such as a substrate by a scan method in which scan processes may be performed using an ink jet head unit 31 including at least one ink jet head having a plurality of nozzles arranged to be overlapped with a desired overlapped region by a size of the desired overlapped region.

Referring to FIGS. 3 to 5, a first pattern may be formed on the object by a first scan process using an ink jet head unit 31 including at least one ink jet head having a plurality of nozzles. A dimensions and/or a shape of the first pattern formed on the object may be identified.

A second pattern may be formed on the object by a second scan process using the ink jet head unit 31 including the at least one ink jet head having the nozzles arranged to be overlapped with the first pattern by a size of a first overlapped region L1. A dimension and/or a shape of the second pattern formed on the object may be identified. Namely, a dimension and/or a shape of a first printed area 33 having the first overlapped region L1 may be identified.

Referring to FIG. 4, a third pattern may be formed on the object by a third scan process using the ink jet head unit 31 including the at least one ink jet head having the nozzles arranged to be overlapped with the second pattern by a size of a second overlapped region L2 substantially larger than the size of the first overlapped region L1. A dimension and/or a shape of the third pattern formed on the object may be identified. That is, a dimension and/or a shape of a second printed area 43 having the second overlapped region L2 substantially larger than the first overlapped region L1 may be identified. In this case, the second overlapped region L2 may have a length substantially larger than a length of the first overlapped region L1 because the second overlapped region L2 may be substantially larger than the first overlapped region L1. Therefore, the second printed area 43 including the second overlapped region L2 may have a length be substantially smaller than a length of the first printed area 33 including the first overlapped region L1.

Referring to FIG. 5, a fourth pattern may be formed on the object by a fourth scan process using the ink jet head unit 31 including the at least one ink jet head having the nozzles arranged to be overlapped with the second pattern by a size of a third overlapped region L3 substantially smaller than the size of the first overlapped region L1. A dimension and/or a shape of the fourth pattern formed on the object may be identified. Namely, a dimension and/or a shape of a third printed area 53 having the third overlapped region L3 substantially smaller than the first overlapped region L1 may be identified. Here, the third overlapped region L3 may have a length substantially smaller than the length of the first overlapped region L1 because the third overlapped region L3 may be substantially smaller than the first overlapped region L1. Thus, the third printed area 53 including the third overlapped region L3 may have a length be substantially larger than the length of the first printed area 33 including the first overlapped region L1.

As described above, a desired pattern (e.g., a pattern desired dimension and/or desired shape) having may be formed on the object by identifying the second pattern including the first printed area 33 having the first overlapped region L1, identifying the third pattern including the second printed area 43 having the second overlapped region L2, and identifying the fourth pattern including the third printed area 53 having the third overlapped region L3. Further, the desired pattern may be formed on the object by the scan processes using the ink jet head unit 31 including the at least one ink jet head having the nozzles arranged to be overlapped with a desired overlapped region by a size of the desired overlapped region.

In some example embodiments, the desired overlapped region may not be limited to the first overlapped region L1 to the third overlapped region L3, and additional overlapped regions may be selected until the desired overlapped region may be identified.

In the printing method according to example embodiments of the invention, the desired pattern may be formed on the object by changing the length of the overlapped region while forming the patterns on the object by more than two scan processes. Therefore, the printing failure of the desired pattern, which may be caused by the supply failure of the droplets that the droplets may not be properly supplied from the nozzles of the at least one ink jet head of the ink jet head unit 31, may be sufficiently compensated.

In example embodiments, the ink jet head unit may include one ink jet head, and the desired pattern may be formed on the object by performing more than two scan processes using the one ink jet head. For example, the scan processes may be carried out using the one ink jet head while changing the overlapped regions of the printed areas, such that the desired pattern may be formed on the object.

In some example embodiments, the ink jet head unit may include a plurality of ink jet heads. The plurality of ink jet heads may be disposed over the object in a substantial line, or the plurality of ink jet heads may be disposed over the object in a substantial step structure along a horizontal direction. Here, adjacent end portions of the plurality of ink jet heads may be substantially overlapped. When the ink jet head unit includes the plurality of ink jet heads, the ink jet head unit may be constructed as a single package, and more than two scan processes may be performed while changing the overlapped regions of the plurality of ink jet heads, so that the desired pattern may be formed on the object.

In other example embodiments, the open and close of the nozzles of the ink jet head unit may be controlled to supply the droplets relative to the overlapped regions of the printed areas during only one of the scan processes. That is, the desired pattern or the desired thin film may be formed on the object by the scan processes in which the lengths of the printed areas may be changed in accordance with the sizes of the overlapped regions.

In other example embodiments, the data indicating the volume, the supply speed of the supplied droplets may be obtained from the ink jet head unit, and thus the failure, for example, strain, of the pattern or the thin film formed on the object may be prevented by numerically analyzing the characteristics of the pattern or the thin film formed using the nozzles based on such data.

In the printing method using the ink jet head unit according to some example embodiments of the invention, the supply failure of the droplets may be sufficiently compensated because the droplets may be provided onto the same position of the object from other overlapped nozzles even though the supply failure of the droplets may be caused at all of the nozzles supplying the droplets onto the same position of the object. Additionally, the supply conditions of droplets from each of the nozzles may be identified and the printing process may be performed on the object while adjusting the length of the nozzles based on the identified supply conditions, so that the thin film or the pattern having the desired uniformity may be formed on the object.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A printing method using an ink jet head unit including a plurality of ink jet heads disposed in a horizontal direction over an object, each of adjacent end portions of the plurality of ink jet heads having more than one overlapped nozzle, the printing method comprising:
identifying a supply of droplets from each of the nozzles of the plurality of ink jet heads;
determining a combination of supplies of the droplets from the nozzles of the plurality of ink jet heads to form a desired pattern on the object; and
forming the desired pattern on the object using the plurality of ink jet heads including the nozzles arranged in accordance with the determined combination of the supplies of the droplets.

2. The printing method using the ink jet head unit of claim 1, further comprising identifying supply conditions of the droplets from each of the nozzles of the plurality of ink jet heads before the determining of the combination of the supplies of the droplets.

3. The printing method using the ink jet head unit of claim 2, wherein the identifying of the supply conditions of the droplets includes identifying whether the droplets are supplied from the nozzles onto the object or not, and identifying a volume of the droplets supplied onto the object.

4. The printing method using the ink jet head unit of claim 1, wherein the ink jet head unit includes three ink jet heads disposed in a step structure.

5. The printing method using the ink jet head unit of claim 1, wherein the identifying of the supply of droplets is performed on overlapped nozzles of the plurality of ink jet heads and/or nozzles disposed at both end portions of a central ink jet head.

6. A printing method using an ink jet head unit including a plurality of ink jet heads disposed in a horizontal direction over an object, each of adjacent end portions of the plurality of ink jet heads having more than one overlapped nozzle, a length in which total nozzles of the plurality of ink jet heads are arranged being defined as a first length, the printing method comprising:
identifying a first pattern formed on the object by supplying droplets onto the object from the nozzles arranged by the first length;
identifying a second pattern formed on the object by changing the length of the nozzles to a second length smaller than the first length, or identifying a third pattern formed on the object by changing the length of the nozzles to a third length larger than the first length in order to form a desired pattern in comparison with the first pattern; and
forming the desired pattern on the object using the ink jet heads having the nozzles arranged by one length of the first length to the third length to the desired pattern.

7. The printing method using the ink jet head unit of claim 6, wherein each of the identifying of the first pattern, the identifying of the second pattern or the identifying of the third pattern is identifying supply conditions of the droplets from each of the nozzles arranged by the first length, the second length or the third length.

8. The printing method using the ink jet head unit of claim 7, wherein the identifying of the supply conditions of the droplets includes identifying whether the droplets are supplied from the nozzles onto the object or not, and identifying a volume of the droplets supplied onto the object.

9. The printing method using the ink jet head unit of claim 6, wherein the ink jet head unit includes three ink jet heads disposed in a step structure.

10. The printing method using the ink jet head unit of claim 6, wherein the length of the nozzles is changed from the first length to the second length or the third length in accordance with supply of droplets from nozzles disposed at end portions of the plurality of ink jet heads.

11. A printing method using an ink jet head unit to form a desired pattern on an object, the printing method comprising:
identifying a first pattern formed on the object by a first scan process using the ink jet head unit;
identifying a second pattern formed on the object by a second scan process using the ink jet head unit including nozzles arranged to be overlapped with the first pattern by a size of a first overlapped region;
identifying a third pattern formed on the object by a third scan process using the ink jet head unit including the nozzles arranged to be overlapped with the second pattern by a size of a second overlapped region larger than the first overlapped region, or identifying a fourth pattern formed on the object by a fourth scan process using the ink jet head unit including the nozzles arranged to be overlapped with the third pattern by a size of a third overlapped region smaller than the first overlapped region; and
forming the desired pattern on the object by an additional scan process using the ink jet head unit including the nozzles arranged to be overlapped with the third pattern or the fourth pattern by a size of a desired overlapped region among the first overlapped region to the third overlapped region.

12. The printing method using the ink jet head unit of claim 11, wherein the ink jet head unit includes at least one ink jet head.

13. The printing method using the ink jet head unit of claim 11, wherein the ink jet head unit includes a plurality of ink jet heads.

14. The printing method using the ink jet head unit of claim 13, wherein the plurality of ink jet heads are disposed in a line over the object.

15. The printing method using the ink jet head unit of claim 13, wherein the plurality of ink jet heads are disposed over the object in a step structure along a horizontal direction, and each of adjacent end portions of the plurality of ink jet heads has an overlapped region.
